(19) United States
(12) Patent Application Publication
(10) Pub. No.: US 2021/0232023 A1
(43) Pub. Date: Jul. 29, 2021

(54) CONNECTOR

(71) Applicant: Yokowo Co., Ltd., Kita-ku, Tokyo (JP)

(72) Inventor: Kenta SUGIURA, Tomioka-shi, Gunma (JP)

(73) Assignee: Yokowo Co., Ltd., Kita-ku, Tokyo (JP)

(21) Appl. No.: 17/059,559

(22) PCT Filed: Apr. 10, 2019
(86) PCT No.: PCT/JP2019/015713

§ 371 Date: Nov. 30, 2020

(30) Foreign Application Priority Data
May 30, 2018 (JP) 2018-103555

(51) Int. Cl. G03B 17/14; H04N 5/225; H01R 13/24

(52) U.S. Cl. CPC G03B 17/14; H01R 13/2407; H04N 5/225

(57) ABSTRACT

A connector includes a sphere serving as a contact portion and a support member rotatably and elastically supporting the sphere. The sphere and the support member form an electrical connection path. The connector may further include a housing fixed to the support member, wherein the housing has a through hole sized such that the sphere cannot pass therethrough, and the sphere protrudes through an opening of the through hole to outside of the housing.

### TECHNICAL FIELD

The present invention relates to a connector used for electrical connection.

### BACKGROUND ART

The following Patent Literature 1 discloses a connector for electrical connection provided in a mechanical connection portion between a camera body and an interchangeable lens. In this connector, by rotating the interchangeable lens with respect to the camera body, a contact point on a. camera body side and a contact-point contacting portion on an interchangeable lens side are brought into contact with each other.

### CITATION LIST

### Patent Literature

Patent Literature 1: JP-A-2017-120308

### SUMMARY OF INVENTION

### Technical Problem

In the connector disclosed in Patent Literature 1, when the interchangeable lens is sliding-fitted to the camera body, a portion of a contact-point contacting portion on the interchangeable lens side that is in contact with the contact point on the camera body side is always fixed in a part of a ridge line or a point. Therefore, when the interchangeable lens is repeatedly attached to and detached from the camera body, there is a drawback that the contact-point contacting portion on the interchangeable lens side is locally worn, and contact failure or corrosion is occurred due to peeling of surface treatment such as plating. Such a problem exists not only in the connection between the camera body and the interchangeable lens but also in general connectors in which contact with a contact point is repeated.

The present invention has been made in view of these circumstances, and an object thereof is to provide a connector capable of preventing local wear.

### Solution to Problem

An aspect of the present invention provides a connector. The connector includes:

a sphere serving as a contact portion; and

a support member rotatably and elastically supporting the sphere,

in which the sphere and the support member form an electrical connection path.

The connector may include a housing fixed to the support member,

the housing may have a through hole sized such that the sphere cannot pass therethrough, and

the sphere may protrude through an opening of the through hole to outside of the housing.

The sphere may be configured to be pushed toward inside of the housing by a terminal to be connected, that is configured to slide so as to cross the through hole.

The support member may be a leaf spring.

The leaf spring may have a structure that both ends thereof are supported.

The leaf spring may include a plurality of tongue piece portions, and the respective tongue piece portions may support the sphere by a surface thereof.

Any combinations of the above components and expressions of the present invention that are converted in methods and systems are also effective as aspects of the present invention.

### Advantageous Effects of Invention

According to the present invention, it is possible to provide a connector capable of preventing local wear.

### BRIEF DESCRIPTION OF DRAWINGS

FIG. 1 is an exploded perspective view of a connector 1 according to a first embodiment of the present invention.

FIG. 2 is a plan view of the connector 1.

FIG. 3 is a front view of the connector 1.

FIG. 4 is a cross-sectional view taken along a line IV-IV in FIG. 2.

FIG. 5 is a bottom view of the connector 1.

FIG. 6 is a cross-sectional view taken along a line VI-VI in FIG. 5.

FIG. 7 is a cross-sectional view showing a first half of a process of bringing a mating terminal 70 into contact with the connector 1 mounted on a substrate 80.

FIG. 8 is a cross-sectional view showing a second half of the process.

FIG. 9 is a perspective view of a connector 2 according to a second embodiment of the present invention.

FIG. 10 is a cross-sectional view showing a process of bringing the mating terminal 70 into contact with a connector 801 mounted on the substrate 80 regarding a Comparative Example 1.

FIG. 11 is a cross-sectional view showing a process of bringing the mating terminal 70 into contact with a connector 802 mounted on the substrate 80 regarding Comparative Example 2.

FIG. 12 is a cross-sectional view showing a state in which the connector 1 according to the first embodiment is mounted on an electric wire 81.

### DESCRIPTION OF EMBODIMENTS

Hereinafter, preferred embodiments of the present invention will be described in detail with reference to the drawings. The same or equivalent components, members or the like illustrated in the drawings are denoted by the same reference numerals, and a repetitive description thereof will be omitted. In addition, the embodiments are not intended to limit the invention but are illustrations, and all the features and combinations thereof described in the embodiments are not necessarily essential to the invention.

(First Embodiment)

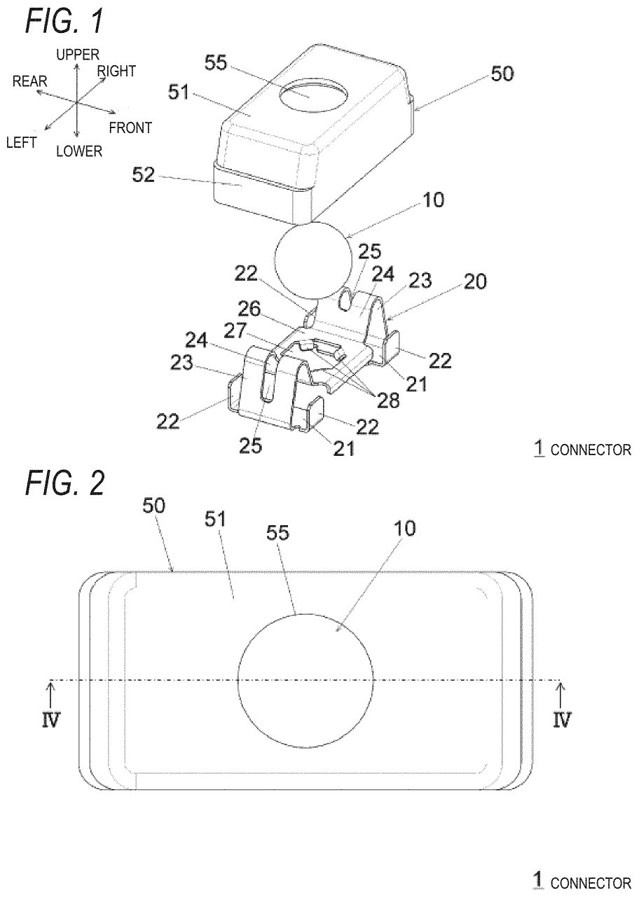

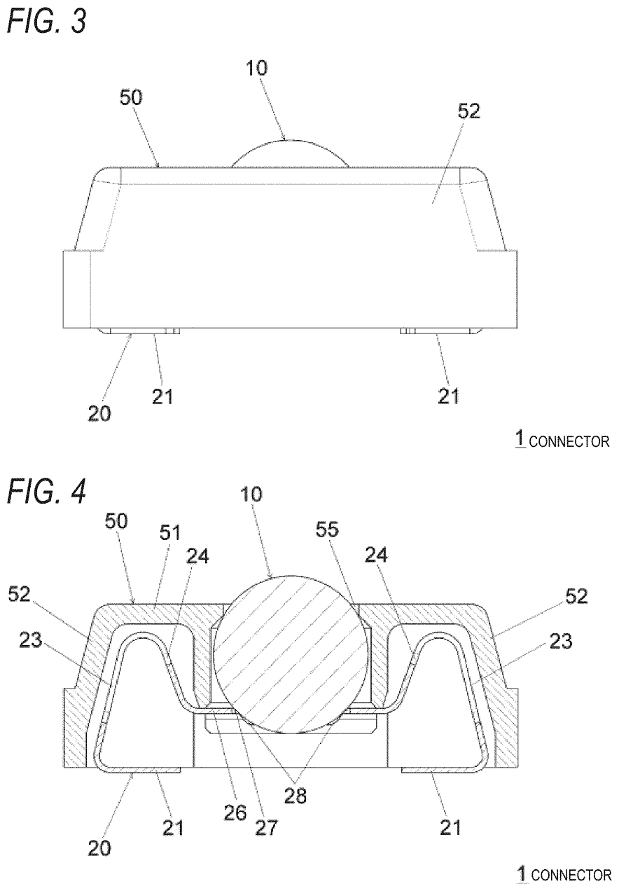

A connector 1 according to a first embodiment of the present invention will be described with reference to FIGS. 1 to 8. FIG. 1 defines front-rear, upper-lower and left-right directions that are three directions orthogonal to the connector 1. The connector 1 is an electrical connector used for electrical connection, and includes a contact ball 10 that is a sphere, a leaf spring 20 formed of a conductive material as a support member, and a housing 50.

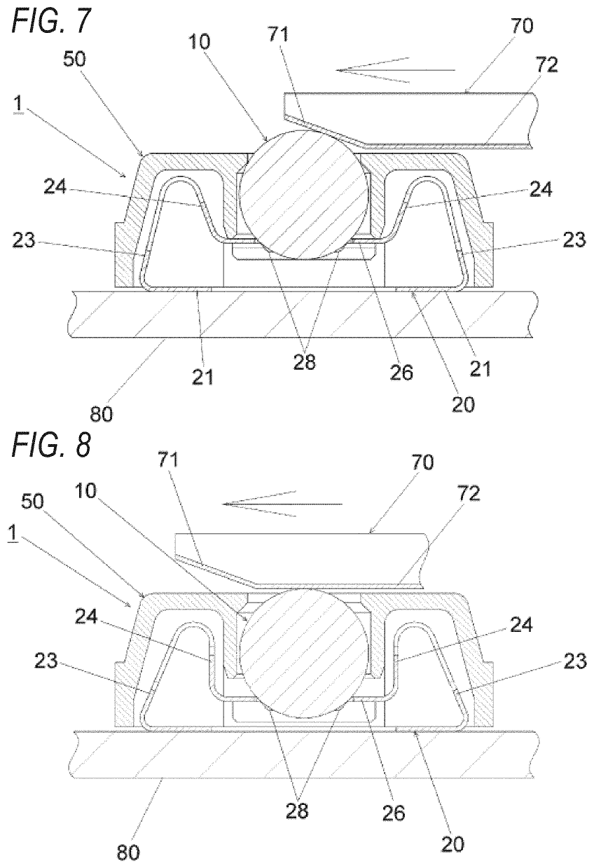

The contact ball 10 is a conductor sphere, and is a metal ball made of, for example, an iron-based material or a copper-based material. A surface of the contact ball 10 may be plated. An example of plating is gold plating. The contact ball 10 may be formed by plating a surface of a non-conductive sphere. The contact ball 10 serves as a contact portion with a mating terminal 70 shown in FIGS. 7 and 8.

The leaf spring 20 rotatably and elastically supports the contact ball 10. The leaf spring 20 is manufactured by sheet metal processing of one metal plate such as copper plate. The leaf spring 20 includes mounting portions 21, press-fitting portions 22, standing portions 23, hanging portions 24, a planar portion 26, a through hole 27 and tongue piece portions 28. The leaf spring 20 has a structure that both ends thereof are supported. The leaf spring 20 is a bilaterally symmetric structure in the illustrated example.

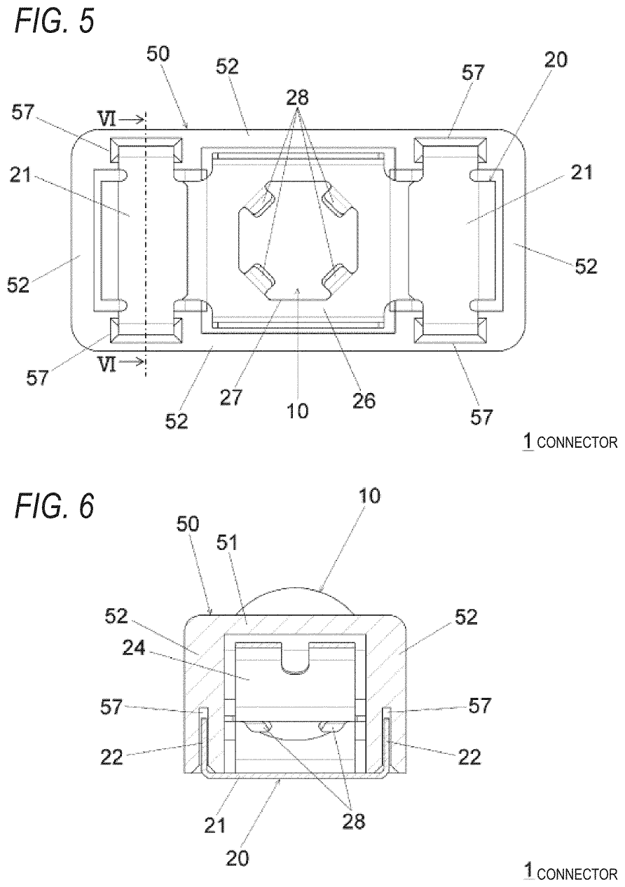

The mounting portions 21 are present on both left and right sides of the leaf spring 20. The mounting portion 21 is a flat surface perpendicular to the upper-lower direction, and is a portion for surface mounting the connector 1 on a substrate 80 as shown in FIGS. 7 and 8. A lower surface of the mounting portion 21 is electrically connected and mechanically fixed to an electrode portion of the substrate 80 by soldering or the like. The press-fitting portions 22 rise vertically and upward respectively from both front and rear end portions of the mounting portion 21. The leaf spring 20 and the housing 50 are fixedly integrated with each other by respectively press-fitting the press-fitting portions 22 into four press-fitting holes 57 (FIGS. 5 and 6) provided on a lower surface of the housing 50.

The left standing portion 23 rises obliquely upward to a right side from a left end portion of the left mounting portion 21. The left hanging portion 24 hangs obliquely downward to the right side from an upper end of the left standing portion 23. A switching portion between the left standing portion 23 and the left hanging portion 24 is a round surface that is convex upward. Since the right standing portion 23 and the hanging portion 24 are bilaterally symmetrical to the left standing portion 23 and the hanging portion 24, a description thereof will be omitted. A punching portion 25 provided across the standing portion 23 and the hanging portion 24 is provided to appropriately set elasticity of the leaf spring 20.

The planar portion 26 has a plane perpendicular to the upper-lower direction, and is provided so as to bridge lower end portions of the left and right hanging portions 24. The through hole 27 is provided at a center portion of the planar portion 26. The four tongue piece portions 28 form a placement portion for the contact ball 10 and extend from the planar portion 26. Each of the tongue piece portions 28 extends downward from an opening edge of the through hole 27 toward a center side of the through hole 27. The tongue piece portions 28 are provided around a center of the through hole 27 at equal angular intervals. A surface (here, a flat surface) of each of the tongue piece portions 28 facing upward contacts an outer peripheral surface of the contact bail 10 and supports the contact ball 10.

The housing 50 is, for example, an insulating resin molded body. The housing 50 accommodates the contact ball 10 and the leaf spring 20 in an internal space defined by an upper surface portion 51 and four side surface portions 52. A through hole 55 is provided at a center portion of the upper surface portion 51. The through hole 55 is sized such that the contact bail 10 cannot pass therethrough. Here, the through hole 55 is a circular hole. An inner diameter of the through hole 55 is smaller than an outer diameter of the contact ball 10. A lower end portion of the through hole 55 expands so as to be tapered. The contact ball 10 protrudes through an upper opening of the through hole 55 to outside of the housing 50 (upward from the upper surface portion 51). The through hole 55 allows the contact ball 10 to protrude and performs as a stopper for the contact ball 10.

The press-fitting holes 57 are provided on lower surfaces of the front and rear side surface portions 52 of the housing 50 (FIGS. 5 and 6). The number of the press-fitting holes 57 is the same as that of the press-fitting portions 22 of the leaf spring 20 (four in this case). A lower end portion of the press-fitting hole 57 expands so as to be tapered. Each press-fitting portion 22 of the leaf spring 20 is press-fitted into each press-fitting hole 57 (FIG. 6).

FIG. 7 is a cross-sectional view showing a first half of a process of bringing the mating terminal 70 into contact with the connector 1 mounted on the substrate 80. FIG. 8 is a cross-sectional view showing a second half of the process. A cross section in FIGS. 7 and 8 is the same as a cross section in FIG. 4. The mating terminal 70 which is an object to be connected by the connector 1 has an inclined surface portion 71 and a flat surface portion 72 that face the contact ball 10 side. The inclined surface portion 71 is inclined with respect to a plane perpendicular to the upper-lower direction. The flat surface portion 72 is perpendicular to the upper-lower direction. As an example, the connector 1 is a connector provided at a mechanical connection portion between a camera body and an interchangeable lens for making electrical connection, the substrate 80 is provided on one of the camera body and the interchangeable lens, and the mating terminal 70 is provided on the other of the camera body and the interchangeable lens. In this case, FIGS. 7 and 8 show states in vicinity of the connector 1 when the interchangeable lens is sliding-fitted to the camera body.

In the state shown in FIG. 7, the contact ball 10 is in contact with an inner surface of the through hole 55 of the housing 50 by being urged by the leaf spring 20. When the mating terminal 70 is moved (sliding) leftward with respect to the connector 1 (so as to cross the through hole 55) from the state shown in FIG. 7, the contact ball 10 moves downward (toward inside of the housing 50) while elastically deforming the leaf spring 20 against the urging of the leaf spring 20 by engaging with the inclined surface portion 71 (in a form of being pushed down by the inclined surface portion 71) (FIG. 8). Thereby, the contact ball 10 elastically comes into contact with the flat surface portion 72. Elastic deformation of the standing portions 23 and the hanging portions 24 of the leaf spring 20 mainly generates an urging force for urging the contact ball 10 upward.

In the process of transitioning from the state shown in FIG. 7 to the state shown in FIG. 8, the contact ball 10 rotates counterclockwise in FIGS. 7 and 8 by a frictional force generated at contact points with the inclined surface portion 71 and the flat surface portion 72. In the state shown in FIG. 8, the contact ball 10 and the leaf spring 20 form an electrical connection path between the mating terminal 70 and the substrate 80. When the mating terminal 70 is moved (sliding) rightward with respect to the connector 1 from the state shown in FIG. 8, the contact ball 10 moves upward until the contact ball 10 comes into contact with the inner surface of the through hole 55 of the housing 50 by being urged by the leaf spring 20. In the process of transitioning from the state shown in FIG. 8 to the state shown in FIG. 7, the contact ball 10 rotates clockwise in FIGS. 7 and 8 by a frictional force generated at the contact points with the inclined surface portion 71 and the flat surface portion 72.

According to the present embodiment, the following operational effects can be achieved.

(1) Since the contact ball 10 rotatably and elastically supported by the leaf spring 20 serves as a contact portion with the mating terminal 70, the contact ball 10 rotates in a process of sliding in contact with the inclined surface portion 71 and the flat surface portion 72. Therefore, it is possible to prevent local wear of the contact ball 10 due to the sliding when connection with the mating terminal 70 is repeated. As a result, occurrences of contact failure and corrosion are prevented. In addition, it is not necessary to take measures such as thickening the plating so as to withstand local wear, and it is possible to achieve both long life and cost reduction.

(2) Since the contact ball 10 is rotatably supported by the leaf spring 20 in all directions, the contact ball 10 can be suitably applied to the sliding of the mating terminal 70 from all directions. Therefore, it is not necessary to regulate a sliding direction of the mating terminal 70.

(3) Since the leaf spring 20 has a structure that both ends thereof are supported, the contact ball 10 can be smoothly and rotatably supported with respect to the sliding of the mating terminal 70 from all directions compared with a case of a cantilever structure.

(4) The contact ball 10 rotates when being pushed downward by the inclined surface portion 71 of the mating terminal 70, whereby it is possible to relieve generation of excessive contact pressure with the mating terminal 70 due to a wrench or the like.

(5) Since the leaf spring 20 supports the contact ball 10 on the surface of the respective tongue piece portions 28 facing upward, an edge portion of the leaf spring 20 does not come into contact with the contact ball 10. Therefore, the contact ball 10 can rotate smoothly, and mutual wear between the leaf spring 20 and the contact ball 10 can be prevented.

(Second Embodiment)

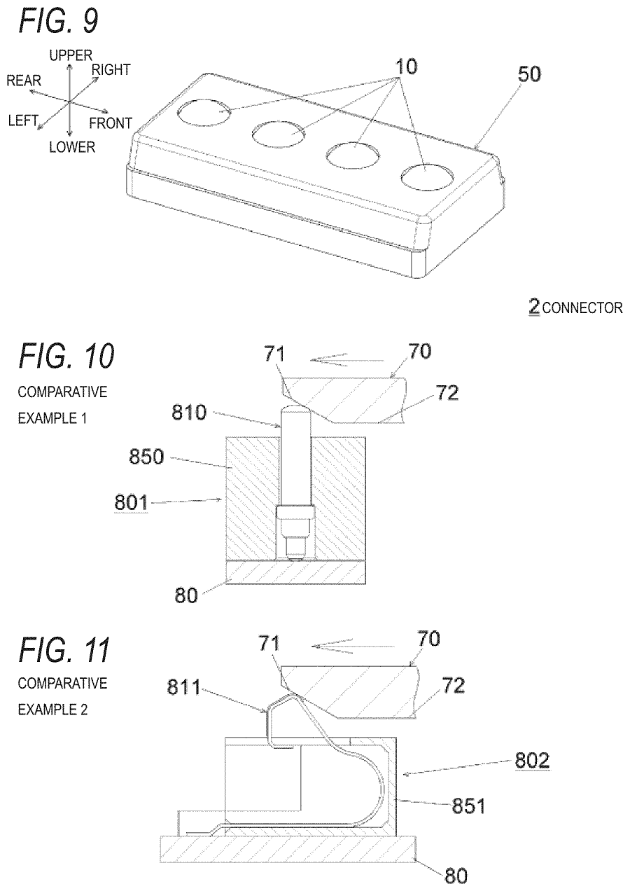

FIG. 9 is a perspective view of a connector 2 according to a second embodiment of the present invention. Compared with the connector 1 according to the first embodiment, the connector 2 differs in that one housing 50 has a plurality of sets (four sets in the illustrated example) of the contact ball 10 and the leaf spring 20 having shapes the same as those in the first embodiment, and is the same in other respects. The contact ball 10 and the leaf spring 20 in each set are combined with the housing 50 in a configuration as same as that in the first embodiment. According to the present embodiment, operational effects as same as those of the first embodiment can be obtained, and a plurality of electrical paths can be provided.

### COMPARATIVE EXAMPLE 1

FIG. 10 is a cross-sectional view showing a process of bringing the mating terminal 70 into contact with a connector 801 mounted on the substrate 80 regarding Comparative Example 1. In the connector 801, a spring probe 810 is supported by an insulating support body 850. In the connector 801, when the spring probe 810 is pushed in by the inclined surface portion 71 of the mating terminal 70, a contact pressure which the spring probe 810 receives from the inclined surface portion 71 (a downward and leftward direction in FIG. 10) is different from a moving direction of the spring probe 810 (a downward direction in FIG. 10), so that a load greater than or equal to the specified load is generated at contact points, resulting in acceleration of wear. In addition, since the wear is locally occurred, there is also a problem of local wear. In contrast, in the embodiments described above, rotation of the contact ball 10 can relieve the load and prevent the wear, and can also prevent the local wear.

### COMPARATIVE EXAMPLE 2

FIG. 11 is a cross-sectional view showing a process of bringing the mating terminal 70 into contact with a connector 802 mounted on the substrate 80 regarding Comparative Example 2. In the connector 802, a leaf spring 811 and a housing 851 are combined. In the connector 802, since the leaf spring 811 has a cantilever structure, there is no problem when the mating terminal 70 is sliding leftward in FIG. 11, but when the mating terminal 70 is sliding vertically or rightward on a paper surface of FIG. 11, normal operation cannot be performed due to catching. Therefore, it is necessary to regulate a sliding direction of the mating terminal 70. In addition, even when the sliding direction is regulated, there is a problem of local wear. In the embodiments described above, since the contact ball 10 is rotatable in all directions, it is possible to normally operate with respect to the sliding of the mating terminal 70 from all directions, and the local wear can also be prevented.

Although the present invention has been described above by taking the embodiments as examples, it will be understood by those skilled in the art that various modifications can be made to each component and each processing process of the embodiments within the scope of the appended claims. Hereinafter, the modifications will be described.

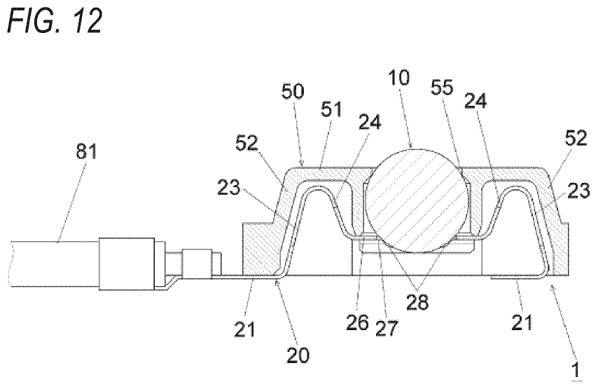

Mounting of the leaf spring 20 on the substrate 80 is not limited to surface mounting, and may be another method such as insertion mounting. An object to which the connectors 1, 2 are mounted is not limited to the substrate, and may be an electric wire. FIG. 12 shows a cross-sectional view in which the connector 1 according to the first embodiment is mounted on an electric wire 81. Connection between the mounting portion 21 and the electric wire 81 may be connection using a crimp terminal or connection using a solder or the like. The support member may be a coil spring. In addition, from a viewpoint of height reduction and ease of assembly, the support member is preferably a leaf spring. Mutual fixing of the leaf spring 20 and the housing 50 is not limited to press-fitting, and may be another method such as adhesion.

### REFERENCE SIGNS LAST

1, 2 connector

10 contact ball

20 leaf spring

21 mounting portion

22 press-fitting portion

23 standing portion

24 hanging portion

25 punching portion

26 planar portion

27 through hole

28 tongue piece portion

50 housing

51 upper surface portion

52 side surface portion

55 through hole

57 press-fitting hole

70 mating terminal

71 inclined surface portion

72 flat surface portion

80 substrate

81 electric wire

1. A connector comprising:
a sphere serving as a contact portion; and
a support member rotatably and elastically supporting the sphere, wherein
the sphere and the support member form an electrical connection path.

2. The connector according to claim 1, further comprising:
a housing fixed to the support member, wherein
the housing has a through hole sized such that the sphere cannot pass therethrough, and
the sphere protrudes through an opening of the through hole to outside of the housing.

3. The connector according to claim 2, wherein
the sphere is configured to be pushed toward inside of the housing by a terminal to be connected, that is configured to slide so as to cross the through hole.

4. The connector according to claim 1, wherein
the support member is a leaf spring.

5. The connector according to claim 4, wherein
the leaf spring has a structure that both ends thereof are supported.

6. The connector according to claim 4, wherein
the leaf spring includes a plurality of tongue piece portions, and the respective tongue piece portions supports the sphere by a surface thereof.
